(19) United States
(12) Patent Application Publication
(10) Pub. No.: US 2006/0124239 A1
(43) Pub. Date: Jun. 15, 2006

(54) Labels and labelling methods

(76) Inventors: Colin Marshall, Wigton (GB); Darren Nash, Wigton (GB); Peter Mills, Wigton (GB)

Correspondence Address: WENDEROTH, LIND & PONACK, L.L.P., 2033 K STREET N. W., SUITE 800, WASHINGTON, DC, 20006-1021, US

(21) Appl. No.: 10/544,630

(22) PCT Filed: Feb. 9, 2004
(86) PCT No.: PCT/EP04/01146

§ 371 Date: Sep. 13, 2005

(30) Foreign Application Priority Data
Feb. 10, 2003 (GB) 0302935.2

(51) Int. Cl. B32B 7/12

(52) U.S. Cl. 156/327; 428/343

(57) ABSTRACT

There is described a method of applying a transparent label of polymeric film to an article to produce a labelled article having a substantial no-label appearance. Labelled articles and labels suitable for use in this method are also described. The labelling method comprises the steps of: (a) selecting films having the following properties (i) Cobb₅ₘᵢₙ value (measured over 5 minutes) from 0.25 to 50 gm⁻²(min.)⁻¹; and (ii) water vapour transmission rate under tropical conditions from 5 to 2000 gm⁻²(24 hr)⁻¹, (b) selecting a liquid adhesive (such as a wet glue) having a viscosity from 1 to 500 Pa·s; and (c) applying the selected adhesive to fix the selected label film to the article where the thickness of the adhesive layer between the article and label on application thereof is from 25 to 150 microns. Preferred labels are clear or coloured laminated cellulose films selected to have Cobb₅ₘᵢₙ from 1.25 to 15 gm⁻²(min.)⁻¹ and WVTRₜᵣₒₚ from 325 to 875 gm⁻²(24 hr)⁻¹. Such films can be applied to a glass bottle using an optional transparent or white wet glue of viscosity from about 40 to about 150 Pa·s (such as starch glue, casein glue, EVA, PVA and/or non-casein based polymeric glue) to give the appearance of no label on the labelled bottle. The adhesive may be applied to give a solid content before drying from 40% to 60% by weight and a dry coat weight from 10 gm⁻² to 125 gm⁻². The preferred time for the label to be fixed in place is from 1 to 20 minutes with the label preferably dry after 5 minutes to 24 hours. This method may be used on a high speed labelling line where 300 to 1,000 labels are applied per minute.

The present invention relates to labelling methods such as wet glue labelling which use a liquid adhesive to fix a label to an article. The invention also relates to use of selected labels and adhesives to achieve an improved no-label look on an article; to labels suitable for use in such methods and uses; and to articles so labelled.

Labels made from thermoplastic films have been conventionally fixed onto an article with pressure sensitive adhesives (PSA) pre-coated onto a label facestock. Such label films include polyolefins such as biaxially oriented polypropylene (BOPP). The PSA label facestock is dispensed from a release liner onto the article to be labelled. An alternative labelling method often used with paper labels is to apply a liquid adhesive to the label just before the label is fixed to the article. The adhesive is usually dispersed in an aqueous medium. The labels used in this method are often referred to as wet glue labels but can also be called cold glue labels or just glue labels.

Recently a ‘no-label’ appearance has become fashionable for PSA labels as retailers have found this is more aesthetically appealing for their products. The appearance of no-label is achieved by applying a transparent and/or translucent label to the article. If the label is transparent, printing on its reverse side (i.e. the “interior” side to be adhered to the article) appears to be directly applied to the article hence the term “no-label look”. Such interior coats are protected by the label from wear and tear (rubbing, attack by solvents etc). However it will be appreciated than a no-label look can also be achieved by printing on the surface of the label which forms the exterior surface of the article.

Paper is conventionally used as substrate for wet glue labels, however as paper is opaque it cannot achieve a no label appearance. However wet glue and PSA labelling methods are very different. The properties required of conventional transparent thermoplastic films (such as oriented polypropylene (OPP, polyester (PE), polyethylene phthalate (PET)) currently used as facestocks for PSA labels are very different from those required for paper wet glue labels. For example thermoplastic films have a higher barrier to moisture (they are neither semi-permeable to water nor good absorbers of water). Aqueous coatings are not easily compatible with and do not adhere well to such thermoplastic films which are often hydrophobic unless the film is surface treated. So a wet glue applied to such films will take much longer to dry and the label will take longer to fix in place. This can be disadvantageous on a high speed labelling line where rapid, precise location of the label on the article is required. So conventional facestocks for PSA labels cannot easily replace paper as a conventional wet glue label. As conventional wet glue labels are opaque and transparent PSA facestock could not be used as a wet glue label it had been previously thought that only PSA labels could achieve satisfactory no-label appearance in a labelled article. Until recently any manufacturer using wet glue labelling equipment who desired a no label appearance for their product was thus faced with the significant capital outlay and disruption of installing PSA equipment to a labelling line.

The applicant's patent application WO 02/074874 describes use of wet glue method to apply a clear biopolymeric label (such as a cellulose film) to a transparent article to achieve a clear no-label look without PSA. This method can use existing machinery suitable for paper wet glue labels yet allows use of biopolymeric labels which have various advantages over paper. The biopolymeric labels can be transparent or translucent to achieve a no-label look. A wet glue on a biopolymeric substrate can also dry in a reasonable time without the need to use exotic coatings. This method now provides an alternative route to a no-label look for manufacturers without the disadvantages of changing an existing label line from wet glue to PSA.

WO 02/074874 teaches that a wet glue should be applied to a cellulose label at a thickness (calculated from the weight of liquid applied) of at least about 10 gm⁻², preferably at least 20 gm⁻², more preferably from about 30 gm⁻² to about 150 gm⁻², most preferably about 50 gm⁻² to about 100 gm⁻². WO 02/074874 also teaches that the water permeability of the cellulose label film should be from about 5 to about 2000 gm⁻²(24 hr)⁻¹, preferably from about 10 to about 1000 gm⁻²(24 hr)⁻¹, more preferably 100 to about 400 gm⁻²(24 hr)⁻¹, most preferably from about 100 to about 500 gm⁻²(24 hr)⁻¹. Example 2 of WO 02/074874 discloses a cellulose wet glue label which is coated on the glue receptive side with a semi-permeable copolymer coating to have a water permeability of 370 gm⁻²(24 hr)⁻¹ (measured in standard test ASTM E 960 at 38° C. and 90% RH).

However there is no teaching in WO 02/074874 that there may be other parameters in addition to water permeability of the film or weight of wet glue applied which may also be usefully controlled. This reference does not suggest how one to optimise properties such as adhesion and optical properties to achieve wet glue labels having improved robustness and no-label appearance when applied to an article. For example WO 02/074874 is silent about the Cobb values of these transparent wet glue films and no coat weight is specified for the optimum properties or amounts of wet glue which should be applied.

The applicant's co-pending application PCT/EP03/07775 describes a method of colour matching a transparent label to the colour of the bottle to which the label is applied by a wet glue method. Colour matching has been found to mask blemishes due to the wet glue process (such as air bubbles in the adhesive) which would otherwise been seen through the transparent label and thus provides a means of improving the no-label appearance.

Surprisingly the applicant has found that that although wet glue has been used for many years to apply paper labels (e.g. to bottles) there are particular issues in applying a transparent label with wet glue and still maintaining a strong illusion that no-label is present. It would also be preferable to achieve a similar or superior no label appearance from a wet glue label compared to a PSA label.

PSA labels have the pressure sensitive adhesive pre-applied during the production of the label stock. This makes it easier to produce a uniform PSA layer of even thickness with few visual blemishes. In contrast the wet glue process requires that a wet adhesive is applied in situ to the label. The wet glue is applied to a glue roller then transferred to rubber covered palettes which transfer the glue onto the reverse of the label. In turn, the label is applied to articles such as glass or PET bottles at typical output speeds of 300 to 1000 articles labelled per minute. In conventional wet glue labels visual defects and unevenness occur in the adhesive layer caused by for example air bubbles, streaking and/or poor adhesive flow. These defects were acceptable for opaque paper labels but are more readily apparent when the wet glue label is transparent and spoil the no-label appearance. At high speeds the adhesive transfer characteristics of wet glue must be optimised to achieve a satisfactory no-label appearance. The wide range of temperature and relative humidity experienced on a labelling line must also be taken into account as for example each label and/or bottle may be wet or dry and warm or cold.

Typically wet glue is applied to conventional paper label by comb shaped applicators which apply the glue in parallel lines where the thickness of glue in each line can be quite deep. A paper wet glue label is required to absorb large amounts of water rapidly. To achieve a no-look appearance the wet glue must be applied to a transparent label much more thinly and evenly as thin stripes of glue would be aesthetically unacceptable. Yet if a label was used having the same rapid and high water absorption capacity as paper a thin coat of conventional wet glue would dry out too quickly before the label could be applied.

Various prior art documents exist which teach that optical properties of a label facestock or label adhesive may be modified.

EP 0664534 A (Fuji Seal) discloses a heat shrinkable label (optionally made from a film of ethylene-vinyl acetate copolymer with an amount of vinyl acetate in the range of 1 to 6% by weight) where the refractive index of the label is in the range of 1.512 to 1.516 in the circumferential direction when fitted to the container, and is in the range of 1.513 to 1.520 in the vertical direction of the container, so that it is even more unlikely that wrinkling or slackening will occur on a surface of the label when heated, as compared with a conventional label made of a polyethylene film. This deals with a completely different problem faced by a separate type of label to that of the present invention.

Some documents in the field of PSA labels teach of specific refractive index values for a PSA used in a transparent label.

EP 1124213 A (Heineken) discloses a clear PSA label where the PSA layer has at least one inorganic particulate material having a particle size not exceeding 50 micron and having a refractive index of between 1.4 and 1.6. This is stated to improve the transparency of the label of the bottle.

WO 0130933 A (3M) discloses PSA labels where the pressure-sensitive adhesive has a refractive index of at least 1.48. The pressure-sensitive adhesives comprise at least one monomer containing a substituted or an unsubstituted aromatic moiety.

However technical solutions which may be suitable for PSA labels made from conventional thermoplastic films such a BOPP would not be considered relevant to improve the no-label appearance of transparent wet glue labels. Ideally the labels are to be used with the minimum of adjustment in wet glue labelling machines that currently use paper labels.

U.S. Pat. No. 6,306,242 (Dronzek) (=WO 99/19412 (Process Resources Corp.)) discloses a method of applying a polymer label to an article with a hydrophilic adhesive by curing the label in situ after it has been applied to the article. On col. 5 lines 30 to 32 (and again on col. 8 lines 46 to 49) the polymeric substrate for this hydrophilic adhesive is stated to include “clear, opaque or colored polypropylene”. Yet this document does not appreciate the particular problems faced with reducing visual blemishes to achieve satisfactory no-label appearance of a transparent label applied by a wet glue.

ExxonMobil have recently launched under the trade name “Label-Lyte XP280” a new metallised 85 micron white BOPP film intended for use as a wet glue label or cut and stack patch labels. This thick multi-layered film is opaque with a mirrored finish. The thickness is necessary due to the special coatings which must be applied to the film to absorb the cold wet glue to allow the glue to dry. This BOPP film has a very low WVTR, it is effectively water impermeable. So these opaque films could not be used to form a wet glue no-look label where a transparent film is required. However if the opaque coating was removed the wet glue would not dry and the label would not adhere to the article.

The Cobb value of a substrate can be measured which is the rate at which a substrate absorbs liquid water during a defined time. This time is usually (e.g. for typical paper label substrates) selected to be over one minute, which is denoted herein as Cobb_{60sec} or simply Cobb. The higher the Cobb value the more rapid the rate of water absorption during this time. Cobb values are conventionally measured in units of gm⁻²(min.)⁻¹.

A document dated 2000 entitled “Ice water resistant labelling adhesives” by Dr Monika Toenniesson (Henkel KGBA, D40191 Düsseldorf) was (at the filing date of the present application) publicly available for download from (“http://www.henkel.com/int_henkel/ai/binary data/en/documents/publications%20icewater.pdf”) part of the web site of the adhesives producer Henkel (“www.henkel.com”). This document (referred to herein ‘Toenniesson’) is concerned with how to reduce the tendency of paper wet glue labels to float off when a labelled bottle is placed in a ice bath cooler. Toenniesson states that the higher the Cobb_{60sec} value of the paper label, the quicker the label floats off as it is less resistant to ice water. Toenniesson recommends a Cobb_{60sec} value of less than 15 gm⁻²(min.)⁻¹ to have ‘a positive impact on ice water resistance’ Typical paper labels used for beer bottles are stated to have Cobb_{60sec} between 10 and 15 gm⁻²(min.)⁻¹ for the front and back labels and between 18 to 21 g/m²(min.)⁻¹ for the neck labels. Toenniesson recommends a higher Cobb value for neck labels to avoid too high a stiffness in the paper. Paper labels which have a Cobb value higher than 20 g/m² are described as very absorbent with a much reduced resistance to ice water.

Toenniesson states that another important factor for ice water resistance is the degree of penetration of water through the front exterior surface of a paper label (denoted as “recto”) to its interior surface attached to the bottle (denoted as “verso”). Toenniesson suggests that metallised and/or varnished papers would provide a good water barrier (‘recto to verso’) and thus improve resistance of the label to ice water. Toenniesson thus implies that a wet glue paper label should have a high water barrier with a WVTR as low as possible, preferably zero. Thus teaches directly away from the WVTR values specified for the present invention. The paper wet glue labels tested by Toenniesson for ice water resistance have previously been fixed to the bottle by a layer of dry adhesive and Toenniesson says that the longer the drying time (preferably more than 14 days) the harder the adhesive layer and therefore the greater the resistance of the label to ice water.

In contrast the present invention is concerned with a method of applying transparent wet glue labels to achieve good adhesion combined with good no label appearance. The applicant has found that it is useful to select a combination of properties in the film and wet glue measured as the label is applied and before the adhesive has dried The Cobb value (over a longer period of 5 minutes) and WVTR of the label are measured with respect to the reverse side of the label (i.e. ‘verso to recto’) as this is the surface to which the wet glue is applied. Optimal drying times for the method of the present invention were found to be less than 14 days as this is too slow for a high speed bottling line.

Toenniesson is not directed towards solving the same problem as the present invention and teaches away from the optimum values used in the labelling method of the present invention. Toenniesson is concerned solely with paper labels and does not consider transparent films. The parameters are measured differently to those described herein. A skilled reader of Toenniesson would have no motivation to replace paper wet glue labels with transparent polymeric films. Alternatively a skilled reader of (for example) WO 02/074874 concerned with the no-look appearance of transparent wet glue labels would have no motivation to refer to Toenniesson which concerns a very different problem of ice water resistance in opaque paper labels.

It is an object of the invention to solve some or all of the problems identified herein, for example to provide a method of labelling articles with an improved no-label look.

The invention relates to the applicants discovery of those adhesive and film parameters which must be controlled in order to maximise the no-label look and achieve a wet glue film label having an much improved aesthetic appearance. In fact although demonstrated herein with respect to wet glues the invention is of broader applicability and may be applied to any combination of a liquid adhesive (e.g. solvent glue) applied to any suitable transparent label film.

To achieve a no-label look with a wet glue on a transparent substrate the applicant has found that a balance must be maintained between acceptable no-label look appearance and label performance. From empirical observations the applicant has identified parameters which it is believed are important in controlling this balance. Some parameters relate to the adhesive properties, some to the film properties.

Wet glues are applied to a label just before the label is fixed to the article to be labelled (such as a bottle). The applicant has found that the water uptake of the label during the first five minutes after applying the wet glue thereto has the most effect on desired label properties such as appearance, fixing and/or drying times. The water uptake by a label film during this important period can thus be measured as described herein by a modified Cobb value taken over a period of 5 minutes (also denoted herein as Cobb₅ₘᵢₙ). The applicant has found that such modified Cobb values of label films can be used (in combination with other parameters) to predict factors such as how well the label fixes to an article and/or the appearance of glue seen through the (transparent) label. The Cobb₅ₘᵢₙ values are also given herein in units of gm⁻²(min.)⁻¹. Unless otherwise stated, all Cobb₅ₘᵢₙ values obtained herein used the standard method described in BSEN 20535:1994, by measuring the uptake of water over an film of area 100 cm² with a head of size 1 cm over a period of 5 minute (compared to 1 minute for the more conventional method to measure Cobb_{60sec} values).

Without wishing to be bound by any mechanism it is believed that too low a value of Cobb₅ₘᵢₙ indicates that during the first five minutes after application of wet glue to a label film, the label does not uptake water sufficiently rapidly from the glue. The viscosity of the adhesive does not rise sufficiently quickly to fix the label in place on a rapidly moving labelling line. This may effect label registration and appearance of the final article. Too high a Cobb₅ₘᵢₙ value indicates the film absorbs water too quickly during the first five minutes after the wet glue has been applied. The glue becomes rapidly viscous and cannot flow to allow defects such as air bubbles to be removed from the adhesive layer. This can have a detrimental effect on the visual appearance of a no-look label. If the Cobb₅ₘᵢₙ value of the film is too high this can even result in the adhesive drying so quickly that there is insufficient time to apply it to the article (as illustrated by for example, comparative example Comp B herein).

A further parameter (when the adhesive is a wet glue) is the water vapour transmission rate (WVTR) of the film. The applicant has also found that WVTR also influences label performance and appearance with wet glue. Without wishing to be bound by any mechanism it is believed that a sufficient WVTR is required so the water is finally removed from the film. Too low a WVTR and the water remains absorbed in the film and/or adhesive which becomes soggy and thus the label is less robust. For example a wet label may lose its mechanical properties or have an undesirable feel. A wet glue may also resorb water from the label, which may cause the label to move or even fall off the article. Yet a film with too high a WVTR may also be undesirable as not only could water evaporate too quickly through the film but also once the label has been applied to the article water may be to readily resorbed through the film during use of the article which would remoisten the adhesive.

WVTR values are conventionally measured using methods such ASTM E96 under two conditions; tropical (at 38° C. and 90% relative humidity, RH) and temperate (at 25° C. and 75% RH). Unless otherwise indicated WVTR values given herein are under tropical conditions. Tropical WVTR values are approximately 2½ times WVTR values under temperate conditions.

A yet further parameter is the viscosity of the adhesive (e.g. wet glue) when applied to the film. The applicant has found that the bounds of viscosity may also be defined by the machine used to apply the adhesive. Often at a labelling station, such as on a bottle line, wet glue is applied vertically to a bottle so adhesive flow is an issue. Without wishing to be bound by any mechanism it is believed that an upper limit of adhesive viscosity is defined by the need for the adhesive to be pumped from the machine reservoir to the applicator. A lower limit of adhesive viscosity is required as too thin an adhesive splashes which causes unevenness and spoils the appearance of the bottle. Splashing is also messy, wasteful and dangerous and can increase costs as for example the labelling machine needs to be cleaned more frequently. Viscosity is measured herein in units of Pa·s (1 Pa·s=1,000 centipoise, or cps). Unless otherwise stated, the adhesive viscosities obtained herein were measured at 24° C. by any suitable known method, such as using a Brookfield viscosity meter.

Yet a still further parameter is the thickness of the adhesive layer applied to the label film. Without wishing to be bound by any mechanism it is believed that if the adhesive coating is too thick it can mar the no-label appearance as it may increase the opacity of the label when applied. However if the layer of glue is very thin then the label may tend to wrinkle or not adhere evenly which also results in a poor appearance. With too thin a layer of glue, then the label may not adhere to the article. Thickness of the adhesive layer may be measured either directly in microns (1 micron=1 μm=1×10⁻⁶ m) or indirectly as the coat weight of glue applied (in gm⁻²) as this corresponds to the depth of the coating. Unless otherwise stated the thickness is of the adhesive layer when dry.

Therefore broadly in accordance with one aspect of the present invention there is provided a method of applying a transparent label of polymeric film to an article to produce a labelled article having a substantial no-label appearance, the method comprising the steps of:

(a) selecting films having the following properties:

(i) Cobb₅ₘᵢₙ value (measured over 5 minutes) of from about 0.25 to about 50 gm⁻²(min.)⁻¹; and
(ii) water vapour transmission rate under tropical conditions (WVTRₜᵣₒₚ measured using ASTM E96 at 38° C. and 90% RH) of from about 5 to about 2000 gm⁻²(24 hr)⁻¹,
   (b) selecting a liquid adhesive having a viscosity of from about 1 to about 500 Pa·s; and
   (c) applying the selected adhesive to fix the selected label film to the article where the thickness of the adhesive layer between the article and label on application thereof is from about 25 to about 150 microns.

It will be appreciated that to select the films and/or adhesives as described herein intermediate measuring steps may be needed. The film or adhesive properties can be measured directly as part of the method, indirectly by others and/or the data can be obtained on other ways for example from the supplier (for example from relevant product data sheets).

Preferably in step (c) the selected adhesive is applied first to the label at the specified thickness and immediately thereafter the adhesive coated label is applied to the article. However it will be appreciated that in another embodiment the adhesive may be applied to a region on the article and then the label immediately applied to said region. In a further embodiment the adhesive may be applied to both the region of the article and to the label which is immediately applied to said region. It will be appreciated that the adhesive is selected and applied in such a manner that it is transparent after application.

Preferably the article to be labelled is a transparent, more preferably is a clear or coloured container such as a bottle, for example a bottle made from glass or plastic (such as PET).

Preferably the method of the invention comprises applying a label to a high speed labelling line, for example at speeds from about 300 to about 1000, more preferably from 500 to 1000 articles labelled per minute. It will be appreciated that the highest speeds may only to achieved in short bursts.

Preferred films have a Cobb₅ₘᵢₙ value from about 0.5 to about 50 gm⁻²(min.)⁻¹; more preferably from about 1.0 to about 30 gm⁻²(min.)⁻¹, most preferably from about 2.0 to about 20 gm⁻²(min.)⁻¹, for example from about 1.25 to about 15 gm⁻²(min.)⁻¹. In an alternative embodiment of the invention preferred films have a Cobb₅ₘᵢₙ value from about 0.7 to about 25 gm⁻²(min.)⁻¹; more preferably from about 1.0 to about 20 gm⁻²(min.)⁻¹, most preferably from about 1.0 to about 10 gm⁻²(min.)⁻¹, for example from about 1.0 to about 5.0 gm⁻²(min.)⁻¹.

Preferred films have a tropical WVTR from about 5 to about 2000 gm⁻²(24 hr)⁻¹, more preferably from about 10 to about 1000 gm⁻²(24 hr)⁻¹, most preferably from about 100 to about 900 gm⁻²(24 hr)⁻¹ and for example from about 325 to about 875 gm⁻²(24 hr)⁻¹. In an alternative embodiment of the invention preferred films have a temperate WVTR from about 30 to about 1000 gm⁻²(24 hr)⁻¹, more preferably from about 80 to about 500 gm⁻²(24 hr)⁻¹, most preferably from about 100 to about 400 gm⁻²(24 hr)⁻¹, especially from about 100 to about 380 gm⁻²(24 hr)⁻¹; and for example from about 130 to about 350 gm⁻²(24 hr)⁻¹

Preferably the liquid adhesive is a wet glue of viscosity from about 20 to about 150 Pa·s, more preferably from about 40 to about 150 Pa·s, most preferably from about 70 to about 130 Pa·s, especially from about 90 to about 120 Pa·s, for example from about 100 to about 120 Pa·s.

Preferably the liquid adhesive selected has total solids contents when applied to the film and/or article (i.e. before the adhesive has dried) of from about 20% to about 80% by weight, more preferably from about 30% to about 70% by weight, most preferably from about 40% to about 60% by weight.

Preferably the adhesive is applied so the thickness of the adhesive layer when dry is from about 10 gm⁻² to about 125 gm⁻², more preferably from about 25 gm⁻² to about 90 gm⁻², and most preferably from about 35 gm⁻² to about 60 gm⁻² In an alternative embodiment of the invention the dry coat weight of the adhesive layer may be from about 25 gm⁻² to about 150 gm⁻², preferably from about 30 gm⁻² to about 125 gm⁻², more preferably from about 50 gm⁻² to about 100 gm⁻², and most preferably from about 60 gm⁻² to about 90 gm⁻².

The time for the film label to cease to move on the article (such as a glass bottle) when gentle sliding pressure was applied is the fixing time. Preferably a label applied to an article according to the method of the invention has a fixing time from about 1 minute to about 20 minutes, more preferably from about 1 minute to about 18 minutes most preferably from about 2 minutes to about 15 minutes, for example from about 5 minutes to about 10 minutes. In a high speed bottling line the time between application of the label to a bottle and placing the filled labelled bottle in crates is typically no more than about 5 minutes, so in an alternative embodiment of the invention the label is at least substantially fixed to the bottle after about 5 minutes (e.g. from about 1 to about 5 minutes), i.e. before crating.

The time taken for the film label to dry to a point where it was unable to be removed using reasonable peeling force is the drying time. Preferably a label applied to an article according to the method of the invention has a drying time from about 5 minutes to about 24 hours, more preferably from about 5 minutes to about 2 hours; most preferably from about 20 minutes to about 1 hour.

Film

It will be appreciated that the any suitable transparent and/or translucent wet glue label facestock in combination with any suitable wet glue may used as described herein to achieve a good no-label appearance, if the label and adhesive are selected to have the parameters given herein. The term ‘transparent’ means ‘to show through’ whereas the term “translucent” means ‘to transmit and diffuse light so that objects beyond cannot be seen clearly’. However in the context of the present invention (unless clearly meant otherwise) the terms translucent and transparent have been used herein interchangeably and the one term may be replaced by and/or has be used to imply the other throughout the specification and claims herein.

In one embodiment of the invention preferred substrates for use as the wet glue label in the method of the invention are any suitable films (modified as necessary) as described, preferred, embodied and/or exemplified in any of WO 02/074874; GB 0216767.4, GB 0222168.7 and/or GB 0222170.3. Optionally any transparent and/or translucent labels also described in U.S. Pat. No. 6,306,242 may also be coloured as described herein.

It will be understood that in the method of the invention a film is selected for use as a wet glue label based on a balance of properties. The label must not absorb water too readily or be too permeable to water otherwise the adhesive dries too quickly creating blemishes. The glue may even dry so quickly that there is insufficient time to apply the label to the article. This is illustrated by the example Comp B herein which is a highly water permeable, uncoated cellulose film. At the other extreme a wet glue label film must not be too impervious to water or have too high a water barrier otherwise the adhesive dries too slowly and the label cannot fix in place quickly and can be easily removed. This is especially undesirable on a high speed labelling line. These properties are illustrated by the example Comp C herein which is a hydrophobic BOPP film with a high water barrier.

To obtain films with the desired optimum parameters one can select a film having inherently the desired Cobb₅ₘᵢₙ and WVTR values without needing further treatment. Alternatively one can adjust the properties of films which lie outside the desired ranges. For example films which are too water permeable and/or absorbent (such as uncoated cellulose) can be modified to reduce their permeability (for example by coating a cellulose film). Similarly films which have too high a barrier to water (such as BOPP or PLA) can be modified to increase their water permeability (for example by micro-perforating a BOPP or PLA film). It will be appreciated that ideally such modifications will not adversely effect the transparency of the film so that the no label appearance of the wet glue label will not be adversely effected. For example any coatings are preferably substantially transparent after application. For similar reasons, preferably any perforations comprise holes which are sufficiently small and/or at a density which will not be noticed visually. Suitable micro-perforation of a film may be achieved for example using an array of fine needles and/or a laser.

Films that may be suitable for use herein as wet glue labels are modified cellulosic films (e.g. by coating) and/or suitably modified polyolefin and/or polylactic acid films (e.g. by micro-perforation). Preferred films comprise coated cellulose, micro-perforated BOPP and/or micro-perforated polylactic acid. More preferred films comprise coated regenerated cellulose and the cellulose film can be made by any of the well known methods. For example the two layer laminated cellulose film available from UCB under the registered trademark Cellophane® WS can be coated with conventional water barrier coatings (such as vinyl chloride/vinyl acetate copolymers and/or polyvinylacetate (PVA) in known amounts to reduce the water absorbance and permeability of the uncoated cellulose to produce coated cellulose films with WVTR and Cobb₅ₘᵢₙ values within the ranges specified herein.

Conveniently the cellulose films used herein may be coated either on both sides or on one side only. More conveniently the film may be uncoated on the side to which adhesive is applied. Most conveniently the cellulose films are substantially free of additives, such as inorganic fillers, which might adversely effect the hydroscopicity of the film.

It will also be appreciated that to obtain consistent results, unless otherwise stated or the context clearly indicates otherwise the values herein relate to measurements made on the film and/or adhesive made under the same conditions. For example unless otherwise stated herein the values herein were measured under tropical conditions (38° C. and 90% RH). It is preferred that cellulose film samples are substantially freshly made before they are tested so any hysteresis effects due to any previous absorptive history of the film can be substantially discounted.

Adhesive

The term ‘wet glue’ denotes adhesive systems which comprise an adhesive in an aqueous carrier and/or diluting medium where the water evaporates or is absorbed by the substrate to set the adhesive. Any suitable type of such water-based adhesives may be used to apply the labels herein. A non limiting list of suitable wet glues comprises vegetable glue; resin cement; animal glue; protein glue; latex cement; suitable combinations thereof and/or suitable mixtures thereof. Preferred wet glues are vegetable glue, resin cement; animal glue and/or protein glue more preferably starch glue, casein glue, EVA, PVA and/or non-casein based polymeric glue. Conveniently the wet glue is not intrinsically strongly coloured, more conveniently is white or substantially transparent. This does not preclude the glue being deliberately coloured to match the label and/or article in a controlled manner by use of additional colorants (as described below).

Vegetable glues (also known as dextrin adhesives) are usually based on starch and/or derivatives thereof. Vegetable glues are relatively cheap adhesives often amber to brown in colour, which can be made with a high viscosity, although they can have low moisture resistance and the dried adhesive can be brittle. Transparent starch based wet glues are preferred.

Resin cements are adhesives comprising an emulsion of polymers such as EVA (Ethylene Vinyl Acetate) and/or PVA (Poly Vinyl Acetate) in an aqueous continuous phase. Resin cements can bond to many substrates and are generally white in colour forming a flexible and clear bond when dry. They have a high degree of moisture resistance although cost more than other wet glues so resin cements may be blended with dextrin to form a hybrid glue.

Animal and/or protein glues comprise two major types: hot glue (derived from animals) and casein glue (derived from milk). Animal glue is amber to brown in colour, is applied at about 60° C. and is initially very tacky when applied to a substrate (although can be diluted with water), but dries to a non tacky film. Casein glue is often light to tan in colour and can be applied at room temperature to form a bond with a high degree of moisture resistance often used for labelling beer, champagne and some types of wine bottles.

Latex cement adhesives are a blend of latex or other elastomers in an emulsion with an aqueous continuous phase. Latex cements are generally white in colour and can be applied to a substrate in many ways. For example the cement may be applied in two parts where a first part is applied to a substrate and dried to form a layer thereon which serves as a contact (or two way) cement. Alternatively the latex cement can be applied to one surface to form a bond as it dries (one way cement). Latex cements can also be formulated to remain tacky and/or become dry to the touch (contact cement).

Any other synthetic or natural equivalent to the above mentioned wet glues may be used, if the glue also has the parameters specified herein.

Examples of suitable wet glues which may be selected having a viscosity with the ranges specified herein comprise:

those starch based transparent wet glues for labelling available from Kaunas University of Technology, Lithuania under the trade names Modeks KA, KD and KDs and which have viscosities within the respective ranges 70 to 100 Pa·s; 70 to 100 Pa·s and 45 to 60 Pa·s;

those casein based wet glues for labelling available commercially from Kic Krones GmbH under trade designations such as Colfix K4002, K40/1 and/or K40K which have respective viscosities of about 70 Pa·s; about 60 Pa·s and 121 Pa·s; and/or

those non casein based polymeric wet glues available commercially from Henkel under trade designations such as Optal 10-7302.

Any suitable method can be used to apply a wet glue adhesive to the labels herein, such any of the following known application methods: using a brush and/or trowel; spray application; from a dispensing nozzle, using suitable applicators; by roll coating: by transfer coating; by screen printing and/or with a curtain coat, either directly to the label or by offset techniques. The method selected will depend on the type of wet glue used and the cost and performance required for the label application proposed. The criteria for selection are well known to those skilled in the art.

In a further aspect of the invention there is provided an article labelled by the method of the present invention. Preferably the article is transparent, more preferably is a clear or coloured container such as a bottle, for example a bottle made from glass or plastic (such as PET).

A still further aspect of the invention provides use of a transparent label of polymeric film selected with properties as described herein and/or use of a liquid adhesive selected with properties as described herein in the manufacture of a labelled article by applying the adhesive to the film in a thickness as described herein to substantially achieve (i) a no-label appearance on the labelled article; (ii) a fixing time as described herein and/or (iii) a drying time as described herein.

A yet other aspect of the invention provides a transparent polymeric film for use in a method of labelling as described herein, the film selected with properties as described herein, where the film is coated on one or both surfaces thereof with a liquid adhesive selected with properties as described herein to form a transparent adhesive layer on the or each surface of the film, the or each layer having a wet thickness from about 25 to about 150 gm⁻².

Further aspects, embodiments and preferred features of the Invention are described in the claims. Preferred embodiments of each of the aspects of the present invention herein correspond to those specified herein for the labelling method of the invention as appropriate.

Other suitable aspects of one or more other compatible labelling processes may be combined with the labelling method of the invention and by analogy in other aspects of the present invention such as the other uses, labels, labelled articles described herein. Some examples of some suitable additional process modifications are given below.

In a cellulose film a suitable (e.g. brown) dye or pigment can be added to the viscose stream (or other media comprising dispersed cellulose) or be absorbed into the regenerated cellulose film. The colorant (type and concentration) may be selected such that the colour of the resultant film web satisfied the equations given in GB 0216767.4, GB 0222168.7, GB 0222170.3 and/or PCT/EP03/07775 (the contents of each of which are hereby incorporated by reference). The film colour is selected with respect to previously measured colour space values for the coloured (e.g. brown) glass bottles to be labelled. This produces a resultant film which is transparent and of the required colour to achieve a no-label appearance on a given coloured glass bottle (e.g. dark brown bottle filled with a very dark beer). Other label films suitable for use in the present invention may be coloured analogously.

The un-inked surface of a label (preferably cellulose label) may be directly marked using a laser to provide alphanumeric characters thereon with for example date, product and/or other coded information. Providing such information without using an ink improves feeding of cellulose labels from a magazine as ink regions of a label (especially at the edge or corners) can increase the stiffness of that region which may lead to mis-feeding and/or mis-alignment of the label especially at high speed. This invention is described in the applicant's co-pending application GB 0304735.4, the contents of which are hereby incorporated by reference.

In a high speed process, preferably a speed of at least 500 articles per minute, the labels may be stacked in a magazine and extracted from the magazine by a pallet by means of a glue film on the pallet surface. This invention is described in the applicant's co-pending application GB 0304736.2, the contents of which are hereby incorporated by reference.

The present invention will now be described in detail with reference to the following non limiting examples which are by way of illustration only.

Preparing Cellulose Labels

The films used in each of the examples herein (Examples 1 and 2 of the invention and comparative examples Comp A, B & C) were prepared by the following method: Twin webs of regenerated cellulose film were created by extrusion of viscose (a solution of cellulose xanthate in 6% sodium hydroxide/water containing 9.3% cellulose) via two slot dies into a 14% solution of sulphuric acid in water using a typical cellulose film casting machine. The resultant gel films were then passed through a series of wash baths to remove residual impurities and then through a bath containing 0.5% of a mixture of yellow, red and blue direct dyes in such proportions as to produce a brown, transparent colouring in the gel films. After further washing to remove excess dye, the films passed through a bath containing plasticisers (a mixture of glycerol and mono-propylene glycol) and also a melamine formaldehyde condensate resin (0.3%) which performed the dual role of laminating adhesive and also as an anchor agent to facilitate the adhesion of (any) coatings applied subsequently to the surfaces of the films. The two gel films were then passed together over a series of heated cylinders where excess water was evaporated and the two films were bonded together as a laminate. This laminate which had a thickness of 45 microns, was separately coated on both surfaces with different lacquers as described below (except for the uncoated films) to prepare different films with a coating on each side of thickness 1 micron when dry.

### PREPARING EXAMPLES

### Example 1

### Coat ‘i’

A lacquer was prepared by dissolving a vinyl chloride/vinyl acetate copolymer in an equal parts mixture of tetrahydrofuran (THF) and toluene. This lacquer is referred to herein as Coat ‘i’ and the resultant coated film as Example 1.

### Example 2

### Coat ‘ii’

A lacquer was prepared by dissolving a polyvinyl acetate (the PVA commercially available from Synthomer under the trade name Mowilith CT5) in an equal parts mixture of tetrahydrofuran (THF) and toluene. This lacquer is referred to herein as Coat ‘ii’ and the resultant coated film as Example 2.

Comp A (Coat ‘a’)

A lacquer was prepared by dissolving a polyvinylidene chloride (PVdC) copolymer in an equal parts mixture of THF and toluene. This lacquer is referred to herein as Coat ‘a’ and the resultant coated film as Comp A, which is a comparative example only.

Comp B

The uncoated laminated cellulose film prepared as described above (referred to herein as Comp B) was also tested below as a wet glue label to provide a comparison (this uncoated cellulose film available commercially from UCB under the registered trademark Cellophane®P).

Comp C

A conventional uncoated film of biaxially oriented polypropylene (BOPP) of 30 micron thickness (referred to herein as Comp C) was also tested as a comparison (this BOPP film available commercially from UCB under the trade designation RGP).

These films (Examples 1, 2 and as a comparisons Comp A, B & C) were each applied to a glass bottle by the method described below. The adhesive selected in each case was a non-casein based polymeric aqueous glue which has been available commercially from Henkel since 17 Sep. 2001 under the trade designation Optal 10-7302M. The glue had a pH of 8.5, solids content of 59%; and viscosity of 115 Pa·s measured at 24° C. using a Brookfield viscosity meter, model number RT 7/20.

Applying Adhesive and Labelling Bottles

The film was cut into a sample 85 mm×65 mm, using a template, with the machine direction orientation of the film length-wise. The adhesive (see above) was spread on a white silicone rubber mat (15 cm×10 cm×4 mm) using a spatula. A Number 2, wire-wound, K-bar applicator was used to draw down the adhesive into a uniform coating on the rubber mat. The cut film sample was pressed on top of the adhesive layer using a piece of paper tissue and air bubbles were removed from under the film by wiping from centre to edge. The film was gently peeled from the adhesive and applied to a clear glass bottle by smoothing the film onto the bottle, using a paper tissue, and gently wiping from centre to edge to remove air bubbles. Using this method about 3 ml of adhesive was applied between each label and the bottle which corresponded to an adhesive thickness/coat weight of approx. 75 gm⁻².

The time for the film label to cease to move on the bottle when gentle sliding pressure was applied was noted for each film sample tested. The time taken for the film label to dry to a point where it was unable to be removed using reasonable peeling force was also noted. The relationship between the Cobb₅ₘᵢₙ value of the film, its temperate WVTR (at 25° C. & 75 RH) and the fixing times (‘Fix’) and drying times (‘Dry’) were then compared (see Table 1, where NM indicates ‘not measured’).

TABLE 1

| Film Sample | | | | |
|---|---|---|---|---|
| (all cellulose | Cobb_{5 min}/ | WVTRₜₑₘₚ/ | Fix/ | Dry/ |
| unless indicated) | gm⁻²(min.)⁻¹ | gm⁻²(24 hr)⁻¹ | mins. | Hours |
| Ex 1 (with coat i) | 1.25 | 130 | 10 | 24 |
| Ex 2 (with coat ii) | 15.0 | 350 | 2 | 1 |
| Comp A (with coat | 0.25 | 4.0 | 20 | 60+ |
| ‘a’) | | | | |
| Comp B (uncoated) | 50.0 | 750 | NM | NM |
| Comp C (uncoated | 0 | 1.5 | days | days |
| BOPP) | | | | |

Results
Ex 1

Example 1 was a cellulose label film which when applied to the bottle with wet glue had a aesthetically pleasing no-look appearance. Coat ‘i’ had modified the cellulose film's absorptive parameters to fall within an optimum region for drying of the wet glue and fixing of the label.

Ex 2

Example 2 was a cellulose label film which when applied to the bottle with the wet glue had a just acceptable no-look appearance. Coat ‘ii’ modified the cellulose film's absorptive parameters sufficiently to reduce crude blemishes seen from the glue. However the appearance of the adhesive could still be improved. Without wishing to be bound by any mechanism it is believed that the label fixes to the bottle in a very short time due to fast removal of water from the adhesive. A slightly slower fixing time may allow more time to form an more uniform adhesive film and thus improve the label appearance even more. So even more optimal films may have a slightly lower Cobb₅ₘᵢₙ value than Example 2, such as less than about 10 gm⁻²(min.)⁻¹.

Comp A

Even though applying the Coat ‘a” to the cellulose the film allows Comp A to fix to a bottle under laboratory conditions, the fixing time would not be sufficiently fast for the high speeds typically encountered on commercially bottling lines. The long drying time also would mean that Comp A may not pass certain preferred additional requirements for labelled bottles such as the well known “ice chest test”.

Comp B

These tests confirm that the uncoated cellulose laminate Comp B is undesirable as a label applied by wet glue. Comp B could not be removed from the rubber mat and could not be applied to the bottle. Without wishing to be bound by any mechanism it is believed that as Comp B has too high a Cobb₅ₘᵢₙ value, the film absorbed water from the adhesive too rapidly, so the film fixed in place almost instantly on the mat giving no time to remove the label and position it on the bottle

Comp C

This uncoated hydrophobic BOPP has a zero Cobb₅ₘᵢₙ value and a very low tropical WVTR (essentially Comp C is impervious to water). Again without wishing to be bound by any mechanism it is believed that after the label is applied to the bottle, water cannot readily escape from the wet glue. The water is trapped between two layers which act as water barriers (the glass bottle & the BOPP film). As the adhesive is unable to dry (at least on any reasonable timescale) the label slides on the liquid adhesive layer can be easily removed from the bottle. It can be seen that this BOPP film has too high a water barrier and insufficient water absorbance to act as a wet glue label.

1. A method of applying a transparent label of polymeric film to an article to produce a labelled article having a substantial no-label appearance, the method comprising the steps of:
(a) selecting films having the following properties
(i) Cobb₅ₘᵢₙ value (measured over 5 minutes) of from about 0.25 to about 50 gm⁻²(min.)⁻¹; and
(ii) water vapor transmission rate under tropical conditions (WVTRₜᵣₒₚ measured using ASTM E96 at 38° C. and 90% RH) of from about 5 to about 2000 gm⁻²(24 hr)⁻¹,
(b) selecting a liquid adhesive having a viscosity of from about 1 to about 500 Pa·s; and
(c) applying the selected adhesive to fix the selected label film to the article where the thickness of the adhesive layer between the article and label on application thereof is from about 25 to about 150 microns.

2. A labelling method as claimed in claim 1, where the label film selected in step (a) comprises a polymer film made from cellulose, a cellulose derivative, a polyolefin and/or polylactic acid.

3. A labelling method as claimed in claim 2, where the film comprises cellulose, micro-perforated biaxially oriented polypropylene (BOPP) and/or micro-perforated polylactic acid (PLA).

4. A labelling method as claimed in claim 3, where the film comprises regenerated cellulose.

5. A labelling method as claimed in claim 1, where the label film selected in step (a) has a Cobb₅ₘᵢₙ value from about 0.5 to about 50 gm⁻²(min.)⁻¹.

6. A labelling method as claimed in claim 5, where the Cobb₅ₘᵢₙ is from about 1.0 to about 30 gm⁻²(min.)⁻¹.

7. A labelling method as claimed in claim 6, where the Cobb₅ₘᵢₙ is from about 2.0 to about 20 gm⁻²(min.)⁻¹.

8. A labelling method as claimed in claim 7, where the Cobb₅ₘᵢₙ is from about 1.25 to about 15 gm⁻²(min.)⁻¹.

9. A labelling method as claimed in claim 6, where the Cobb₅ₘᵢₙ is from about 0.7 to about 25 gm⁻²(min.)⁻¹.

10. A labelling method as claimed in claim 9, where the Cobb₅ₘᵢₙ is from about 1.0 to about 20 gm⁻²(min.)⁻¹.

11. A labelling method as claimed in claim 10 where the Cobb₅ₘᵢₙ is from about 1.0 to about 10 gm⁻²(min.)⁻¹.

12. A labelling method as claimed in claim 11, where the Cobb₅ₘᵢₙ is from about 1.0 to about 5.0 gm⁻²(min.)⁻¹.

13. A labelling method as claimed in claim 1, in which the label film selected in step (a) has a WVTRₜᵣₒₚ, from about 10 to about 1000 gm⁻²(24 hr)⁻¹.

14. A labelling method as claimed in claim 13, where the WVTRₜᵣₒₚ is from about 100 to about 900 gm⁻²(24 hr)⁻¹.

15. A labelling method as claimed in claim 14, where the WVTRₜᵣₒₚ is from about 325 to about 875 gm⁻²(24 hr)⁻¹.

16. A labelling method as claimed in claim 1, where the label film selected in step (a) is also selected to have a temperate water vapor transmission rate (WVTRₜₑₘₚ measured using ASTM E96 at 25° C. and 75% RH) from about 30 to about 1000 gm⁻²(24 hr)₋₁.

17. A labelling method as claimed in claim 16, where the WVTRₜₑₘₚ is from about 80 to about 500 gm⁻²(24 hr)⁻¹.

18. A labelling method as claimed in claim 17, where the WVTRₜₑₘₚ is from about 100 to about 400 gm⁻²(24 hr)⁻¹.

19. A labelling method as claimed in claim 18, where the WVTRₜₑₘₚ is from about 100 to about 380 gm⁻²(24 hr)⁻¹.

20. A labelling method as claimed in claim 19, where the WVTRₜₑₘₚ is from about 130 to about 350 gm⁻²(24 hr)⁻¹.

21. A labelling method as claimed in claim 1, where the liquid adhesive selected in step (b) is a wet glue comprising one or more: vegetable glue(s); resin cement(s); animal glue(s); protein glue(s); latex cement(s); suitable combinations thereof and/or suitable mixtures thereof.

22. A labelling method as claimed in claim 21, where the wet glue comprises vegetable glue, resin cement; animal glue and/or protein glue.

23. A labelling method as claimed in claim 22, where the wet glue is starch glue, casein glue, EVA, PVA and/or non-casein based polymeric glue.

24. A labelling method as claimed in claim 23, where the wet glue (before any optional colorants are added) is transparent and/or white.

25. A labelling method as claimed in claim 1, where the adhesive selected in step (b) has a viscosity from about 20 to about 150 Pa·s.

26. A labelling method as claimed in claim 25, where the viscosity is from about 40 to about 150 Pa·s.

27. A labelling method as claimed in claim 28, where the viscosity is from about 70 to about 130 Pa·s.

28. A labelling method as claimed in claim 27, where the viscosity is from about 90 to about 120 Pa·s.

29. A labelling method as claimed in claim 28, where the viscosity is from about 100 to about 120 Pa·s.

30. A labelling method as claimed in claim 1, where in step (c) the adhesive layer has a total solids contents before drying from about 20% to about 80% by weight.

31. A labelling method as claimed in claim 30, where the solids content is from about 30% to about 70% by weight.

32. A labelling method as claimed in claim 31, where the solids content is from about 40% to about 60% by weight.

33. A labelling method as claimed in claim 1, where in step (c) the thickness of the adhesive layer applied (measured when dry) is from about 10 gm⁻² to about 125 gm⁻².

34. A labelling method as claimed in claim 33, where the dry thickness is from about 25 gm⁻² to about 90 gm²⁻².

35. A labelling method as claimed in claim 34, where the dry thickness is from about 35 gm⁻² to about 60 gm⁻².

36. A labelling method as claimed in claim 35, where the dry thickness is from about 25 gm⁻² to about 150 gm⁻².

37. A labelling method as claimed in claim 36, where the dry thickness is from about 30 gm⁻² to about 125 gm⁻².

38. A labelling method as claimed in claim 37, where the dry thickness is from about 50 gm⁻² to about 100 gm²⁻².

39. A labelling method as claimed in claim 38, where the dry thickness is from about 60 gm⁻² to about 90 gm⁻².

40. A labelling method as claimed in claim 1, where the time taken after step (c) for the label film to cease to move on the article when gentle sliding pressure is applied thereto, referred to herein as the fixing time, is from about 1 minute to about 20 minutes.

41. A labelling method as claimed in claim 40, where the fixing time is from about 1 minute to about 18 minutes.

42. A labelling method as claimed in claim 41, where the fixing time is from about 2 minutes to about 15 minutes.

43. A labelling method as claimed in claim 42, where the fixing time is from about 5 minutes to about 10 minutes.

44. A labelling method as claimed in claim 41, where the fixing time is from about 1 minute to about 5 minutes.

45. A labelling method as claimed in claim 1, where the time taken after step (c) for the label film to dry to a point where the film cannot be removed using reasonable peeling force (referred to herein as the drying time) is from about 5 minutes to about 24 hours.

46. A labelling method as claimed in claim 45, where the drying time is from about 5 minutes to about 2 hours.

47. A labelling method as claimed in claim 46, where the drying time is from about 20 minutes to about 1 hour.

48. A labelling method as claimed in claim 47, where the article which is labelled comprises a colored and/or transparent container comprising glass and/or polyethylene phthalate (PET).

49. A labelling method as claimed in claim 48, where the article is a colored or clear glass bottle.

50. A labelling method as claimed in claim 1, where the labels are applied to the articles at a speed from about 300 to about 1000 labels per minute.

51. A labelled article obtained and/or obtainable by a labelling method as claimed in claim 1 where the label has a no-label appearance on the article.

52. (canceled)

53. A transparent polymeric film for use in a method of labelling as described in claim 1, where the film is coated on one or both surfaces thereof with a liquid, aqueous, wet glue adhesive to form a transparent adhesive layer on the or each surface of the film, the or each layer having a wet thickness from about 25 to about 150 gm⁻².
